(19) United States
(12) Patent Application Publication
(10) Pub. No.: US 2024/0285103 A1
(43) Pub. Date: Aug. 29, 2024

(54) Collectible Coin Holder

(71) Applicant: Provenance NGC LLC, LAKEWOOD RANCH, FL (US)

(72) Inventors: Eloy Nunez, Ellenton, FL (US); Craig Fiumara, Sarasota, FL (US); Max Spiegel, Sarasota, FL (US); Scott Schechter, Sarasota, FL (US); Joseph Yanarella, Wellington, FL (US); Stephen Lam, Hong Kong (CN)

(21) Appl. No.: 18/574,024

(22) PCT Filed: Jun. 23, 2022
(86) PCT No.: PCT/US2022/034806

§ 371 Date: Dec. 23, 2023

Related U.S. Application Data
(60) Provisional application No. 63/214,259, filed on Jun. 23, 2021.

(51) Int. Cl. A47G 1/12

(52) U.S. Cl. CPC A47G 1/12

(57) ABSTRACT

A collectible coin can be enveloped between two sheets of thin clear flexible plastic. The two sheets, with the coin centered on and between them, can be heat sealed together around a perimeter to create a coin envelope. The coin envelope can be secured around the perimeter by a snap-together assembly including front and back parts of a holder. The coin envelope and/or the front and/or back parts of the holder can include one or more alignment features that fix the rotational alignment of the envelope along with the enveloped coin within the snap-together assembly. The front and back parts can also secure and display a certification label describing the coin. The front and back parts with the coin envelope and certification label can be securely enclosed in a tamper-evident protective clear plastic case. The sheets can be made of, for example, polyethylene terephthalate glycol or polyethylene terephthalate.

### RELATED APPLICATIONS

The subject matter of this application is related to U.S. Provisional Application No. 63/214,259, filed on 2021 Jun. 23, which is hereby incorporated by reference in its entirety.

### SUMMARY OF THE INVENTION

A collectible coin can be enveloped between two sheets of thin clear flexible plastic. The two sheets, with the coin centered on and between them, can be heat sealed together around a perimeter to create a coin envelope. The coin envelope can be secured around the perimeter by a snap-together assembly including front and back parts of a holder. The coin envelope and/or the front and/or back parts of the holder can include one or more alignment features that fix the rotational alignment of the envelope along with the enveloped coin within the snap-together assembly. The front and back parts can also secure and display a certification label describing the coin. The front and back parts with the coin envelope and certification label can be securely enclosed in a tamper-evident protective clear plastic case.

The sheets can be made of, for example, polyethylene terephthalate glycol (PETG) or polyethylene terephthalate (PET). The parts of the holder can be made of, for example, acrylonitrile butadiene styrene (ABS). The case can be made of, for example, polycarbonate. The certification label can be made of, for example, paper or plastic film with printing thereon.

A collectible coin holder can include: a coin envelope formed of two sheets of transparent flexible material encasing a collectible coin positioned between the two sheets, the two sheets being sealed together around a portion of a perimeter of the coin envelope to secure the coin between the two sheets; a front part formed of plastic and having a label holding area holding a label; and a back part formed of plastic, wherein the front part and the back part have interior faces that are snapped together to secure the coin envelope in a viewing opening that extends through the front part and the back part, and wherein at least one of the front part and the back part have a recess surrounding the viewing opening on an interior face, the recess shaped to match a portion of the perimeter of the coin envelope.

In one embodiment, each of front part and the back part have a recess and the recesses have a combined depth configured to accommodate a thickness of the coin envelope at the perimeter of the coin envelope.

In one embodiment, only the front part has a recess, and the recess has a depth configured to accommodate a thickness of the coin envelope at the perimeter of the coin envelope.

In one embodiment, only the back part has a recess, and the recess has a depth configured to accommodate a thickness of the coin envelope at the perimeter of the coin envelope.

In one embodiment, the perimeter of the coin envelope is generally circular in shape and further has a cutout in the circular shape, and wherein the recess of the front part or the back part includes a protrusion configured to engage with the cutout to rotationally secure the coin envelope in the viewing opening.

In one embodiment, the perimeter of the coin envelope is generally circular in shape and further has a protrusion from the circular shape.

In one embodiment, the recess of the front part or the back part includes a cutout configured to engage with the protrusion to rotationally secure the coin envelope in the viewing opening.

In one embodiment, the perimeter of the coin envelope is not generally circular in shape.

In one embodiment, the two sheets are sealed together using heat.

In one embodiment, the viewing opening is circular.

In one embodiment, the coin holder can further include: two overhangs formed in the front part, each overhang extending over a portion of the label along one of two opposite sides of the label in position on the label holding area; and at least two projections extending from the back part, each projection positioned to press a portion of an underside of the label on one of the opposite sides against one of the overhangs to secure the label in place.

A cased collectible coin can include: a collectible coin holder as described above; the collectible coin encased within the coin envelope of the collectible coin holder; and a transparent plastic outer case comprising a front part ultrasonically welded to a back part and encasing the collectible coin holder.

A method can include: sealing a collectible coin between two sheets of transparent flexible material to form a coin envelope having a sealed perimeter; placing the coin envelope in a recess formed around a viewing opening in a front part or a back part of a collectible coin holder, wherein the front part has a label holding area holding a label; and snapping the front part and the back part together to secure the coin envelope in the viewing opening between the front part and the back part.

In one embodiment, each of front part and the back part have a recess and the recesses have a combined depth configured to accommodate a thickness of the coin envelope at the perimeter of the coin envelope.

In one embodiment, only the front part has a recess, and the recess has a depth configured to accommodate a thickness of the coin envelope at the perimeter of the coin envelope.

In one embodiment, only the back part has a recess, and the recess has a depth configured to accommodate a thickness of the coin envelope at the perimeter of the coin envelope.

In one embodiment, the perimeter of the coin envelope is generally circular in shape and further has a cutout in the circular shape, and wherein the recess of the front part or the back part includes a protrusion configured to engage with the cutout to rotationally secure the coin envelope in the viewing opening.

In one embodiment, the perimeter of the coin envelope is generally circular in shape and further has a protrusion from the circular shape.

In one embodiment, the recess of the front part or the back part includes a cutout configured to engage with the protrusion to rotationally secure the coin envelope in the viewing opening.

In one embodiment, the perimeter of the coin envelope is not generally circular in shape.

As will be appreciated by one skilled in the art, multiple aspects described in this disclosure can be variously combined in different operable embodiments. All such operable combinations, though they may not be explicitly set forth in the interest of efficiency, are specifically contemplated by this disclosure.

### BRIEF DESCRIPTION OF THE DRAWINGS

FIG. 1 is a perspective view of a collectible coin holder.

FIG. 2 is an elevation view of a front side of the holder.

FIG. 3 is an elevation view of a back side of the holder.

FIG. 4 is an elevation view of a left side of the holder.

FIG. 5 is an elevation view of a right side of the holder.

FIG. 6 is an elevation view of a top side of the holder.

FIG. 7 is an elevation view of a bottom side of the holder.

FIG. 8 is a cross-sectional view of the holder.

FIG. 9 is a perspective exploded view of the holder in accordance with a first embodiment.

FIG. 10 is a perspective view of the holder enclosed in an outer transparent case.

FIG. 11 is a perspective exploded view of an assembly of the holder with front and back parts of the outer transparent case.

FIG. 12 is a perspective view of an interior side of a front part of the holder in accordance with the first embodiment.

FIG. 13 is an elevation view of the interior side of the front part of the holder in accordance with the first embodiment.

FIG. 14 is an elevation view of the interior side of a back part of the holder in accordance with the first embodiment.

FIG. 15 is a perspective exploded view of the holder in accordance with a second embodiment.

FIG. 16 is a perspective view of an interior side of a front part of the holder in accordance with the second embodiment.

FIG. 17 is an elevation view of the interior side of the front part of the holder in accordance with the second embodiment.

FIG. 18 is an elevation view of the interior side of a back part of the holder in accordance with the second embodiment.

FIG. 19 is a perspective exploded view of the holder in accordance with a third embodiment.

FIG. 20 is a perspective view of an interior side of a front part of the holder in accordance with the third embodiment.

FIG. 21 is an elevation view of the interior side of the front part of the holder in accordance with the third embodiment.

FIG. 22 is an elevation view of the interior side of a back part of the holder in accordance with the third embodiment.

FIG. 23 is a perspective exploded view of the holder in accordance with a fourth embodiment.

FIG. 24 is a perspective view of an interior side of a front part of the holder in accordance with the fourth embodiment.

FIG. 25 is an elevation view of the interior side of the front part of the holder in accordance with the fourth embodiment.

FIG. 26 is an elevation view of the interior side of a back part of the holder in accordance with the fourth embodiment.

FIG. 27 illustrates a cutaway cross section view of the holder sliced from one side towards the other along one of the ribs.

Medium-short dashed broken lines in the figures are not indicative of any structure and should be disregarded.

### DETAILED DESCRIPTION

In the following description, references are made to various embodiments in accordance with which the disclosed subject matter can be practiced. Some embodiments may be described using the expressions one/an/another embodiment or the like, multiple instances of which do not necessarily refer to the same embodiment. Particular features, structures or characteristics associated with such instances can be combined in any suitable manner in various embodiments unless otherwise noted. By way of example, this disclosure may set out a set or list of a number of options or possibilities for an embodiment, and in such case, this disclosure specifically contemplates all clearly feasible combinations and/or permutations of items in the set or list.

A collectible coin can be enveloped between two sheets of thin clear flexible plastic. The two sheets, with the coin centered on and between them, can be heat sealed together around a perimeter to create a coin envelope. The coin envelope can be secured around the perimeter by a snap-together assembly including front and back parts of a holder. The coin envelope and/or the front and/or back parts of the holder can include one or more alignment features that fix the rotational alignment of the envelope along with the enveloped coin within the snap-together assembly. The front and back parts can also secure and display a certification label describing the coin. The front and back parts with the coin envelope and certification label can be securely enclosed in a tamper-evident protective clear plastic case.

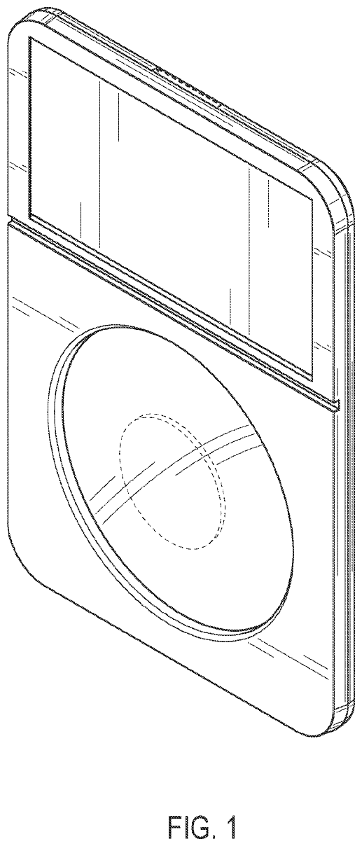

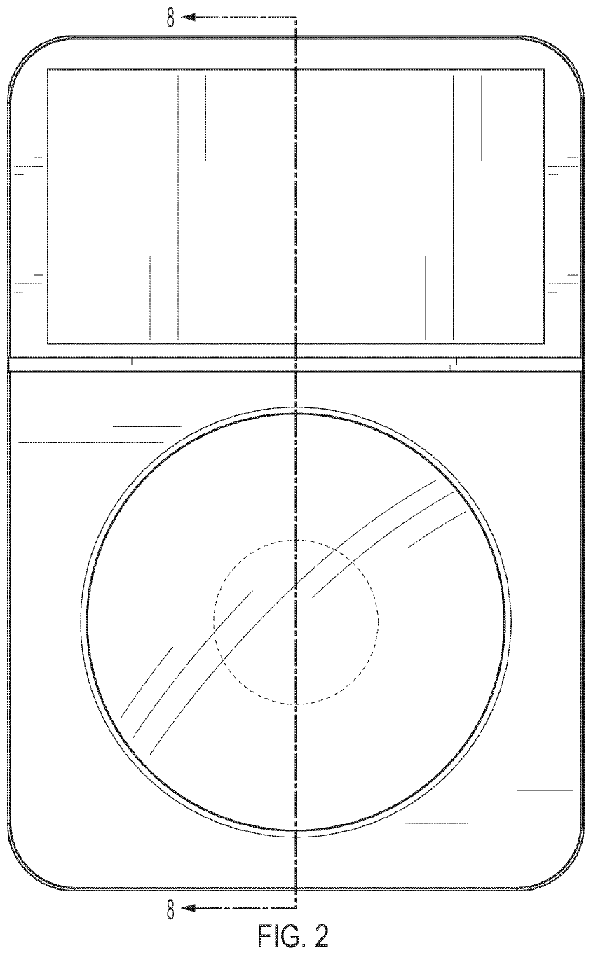

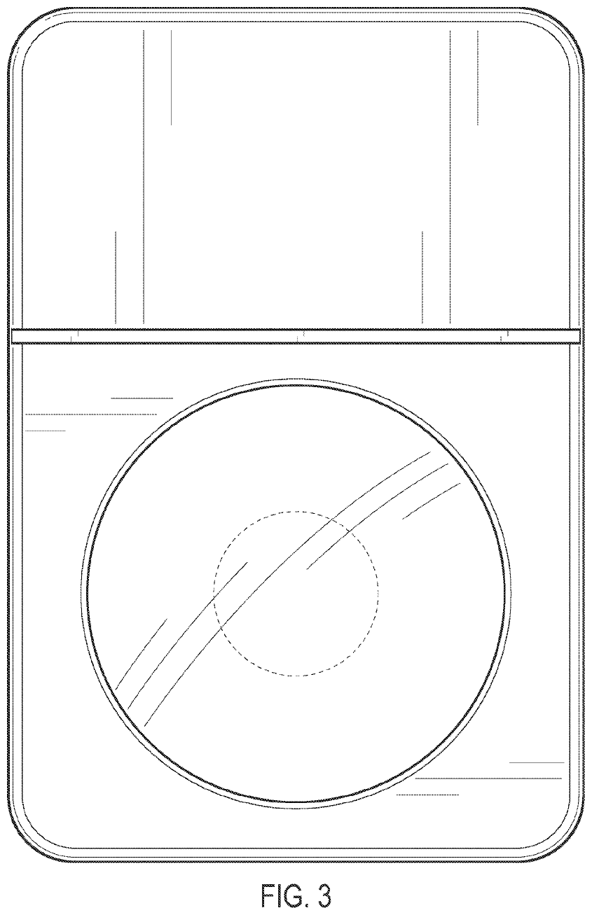

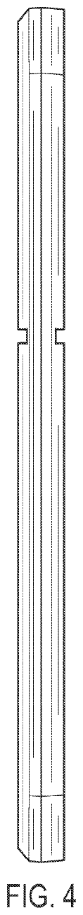

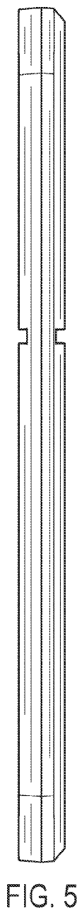

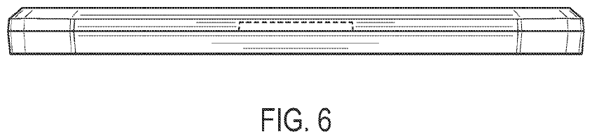

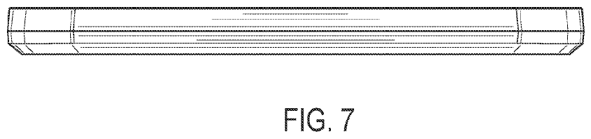

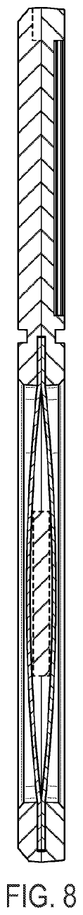

FIG. 1 is a perspective view of a collectible coin holder. A collectible coin held in the holder is shown in broken lines. FIG. 2 is an elevation view of a front side of the holder. Long-short dashed broken lines with arrows labelled 8 indicate sight lines for FIG. 8. FIG. 3 is an elevation view of a back side of the holder. FIG. 4 is an elevation view of a left side of the holder. FIG. 5 is an elevation view of a right side of the holder. FIG. 6 is an elevation view of a top side of the holder. FIG. 7 is an elevation view of a bottom side of the holder. FIG. 8 is a cross-sectional view of the holder viewed in accordance with the sight lines shown in FIG. 2.

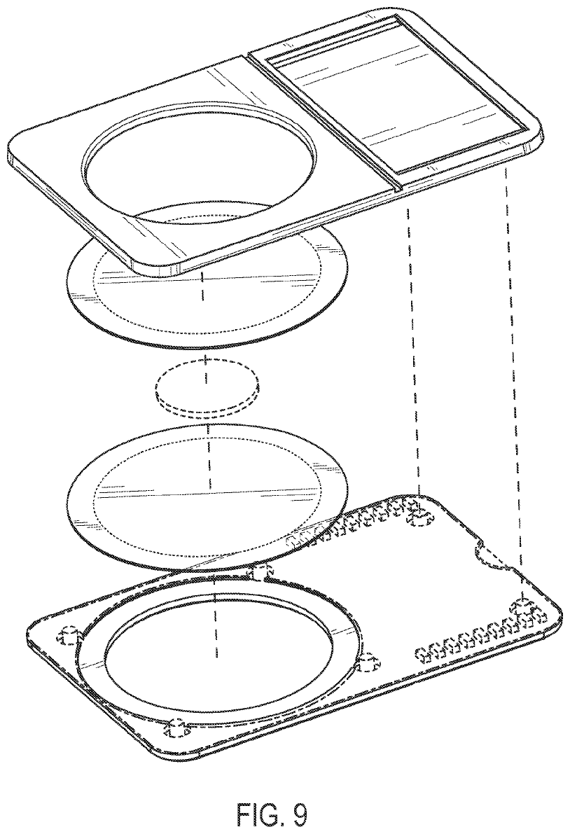

FIG. 9 is a perspective exploded view of the holder in accordance with a first embodiment. The dotted circles indicate different regions of the sheets of the envelope including an outer perimeter region where the two sheets can be heat sealed together, and an inner region, which is visible through a viewing opening of the holder when the envelope is secured within the holder. Additional features of the holder are shown in broken lines. Medium-short dashed broken lines are not indicative of any structure and should be disregarded.

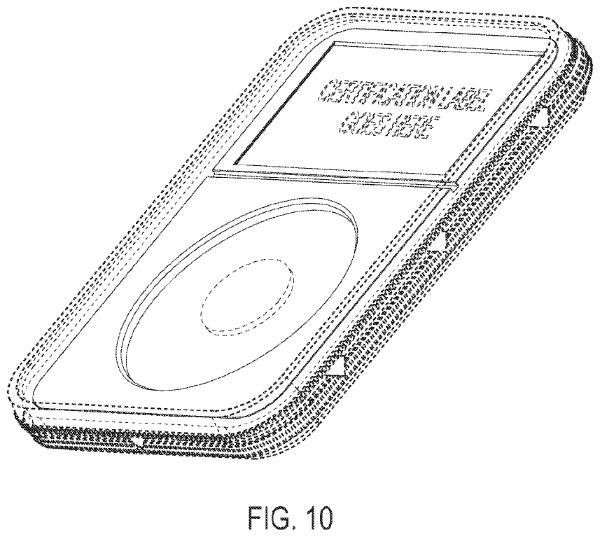

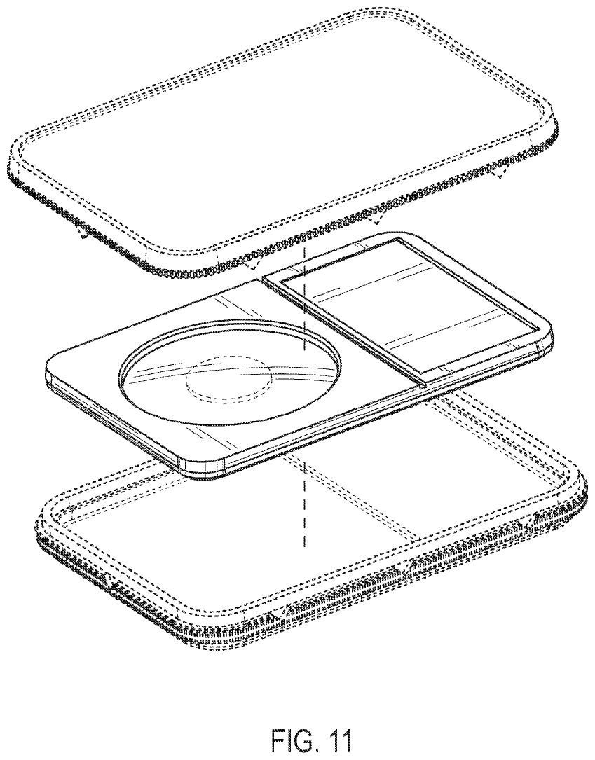

FIG. 10 is a perspective view of the holder enclosed in an outer transparent case. The outer transparent case is shown in broken lines. A certification label is shown in a label holding area and recites in broken line text “CERTIFICATION LABEL GOES HERE”. FIG. 11 is a perspective exploded view of an assembly of the holder with front and back parts of the outer transparent case. The front and back parts of the outer transparent case can be ultrasonically welded together enclosing the holder to create a cased collectible coin.

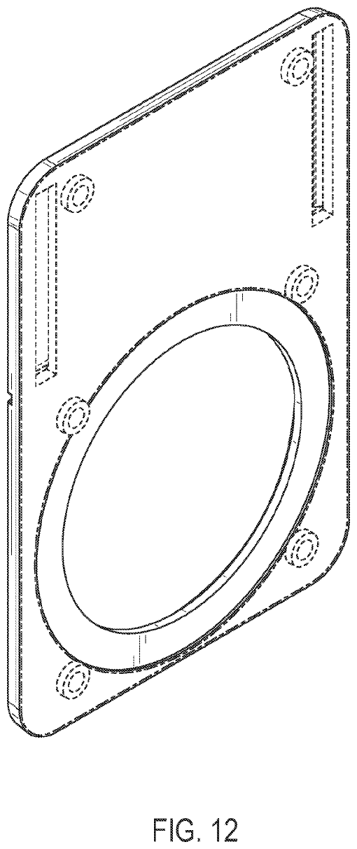

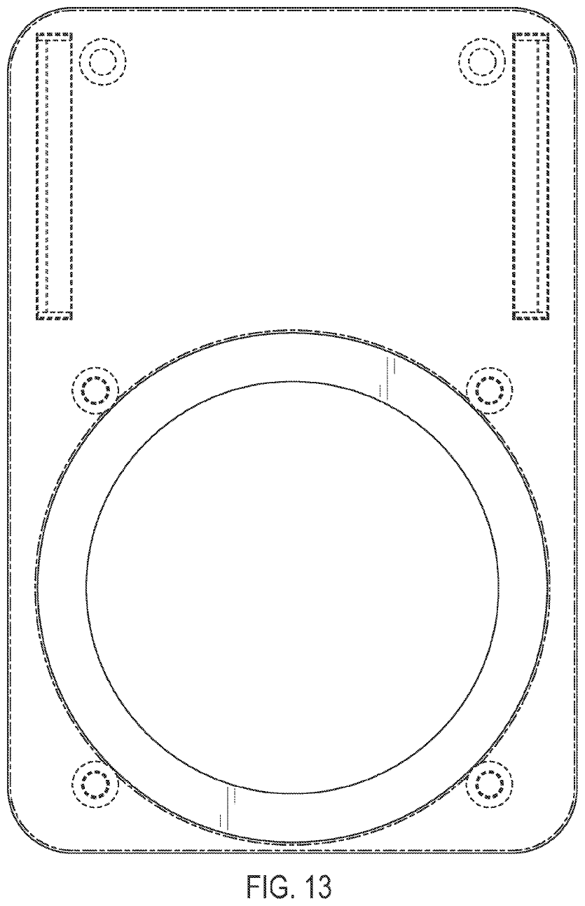

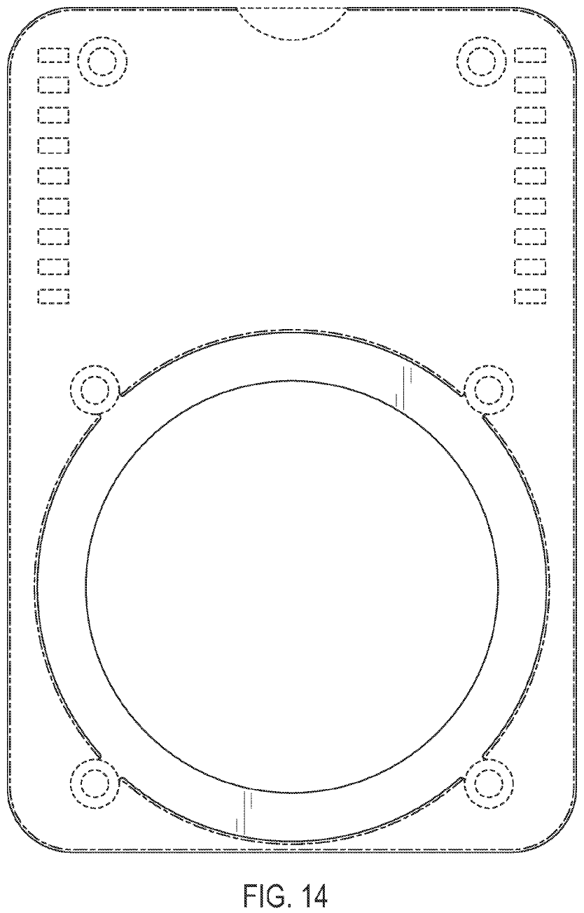

FIG. 12 is a perspective view of an interior side of a front part of the holder in accordance with the first embodiment. FIG. 13 is an elevation view of the interior side of the front part of the holder in accordance with the first embodiment. FIG. 14 is an elevation view of the interior side of a back part of the holder in accordance with the first embodiment. Medium-short dashed broken lines are not indicative of any structure and should be disregarded.

Referring to FIG. 9, the exploded view shows a front part of the holder above a first sheet of clear flexible plastic then a collectible coin. Below the collectible coin are shown a second sheet of clear flexible plastic and then a back part of the holder. The coin envelope can be formed of a heat sealed assembly of the two sheets and the coin. A perimeter heat sealed portion of the envelope, indicated outside the dotted circles on the sheets, can fit within a recess formed in one or both of the front and back parts of the holder.

Referring to FIGS. 9, 12, 13 and 14, six interlocking pins and receptacles are formed in the back and front parts of the holder respectively. The pins and receptacles are sized to allow the front and back parts to be snapped together as an assembly to secure the coin envelope. Other mechanisms for securing the front and back parts can be used, such as clips or snaps with associated receptacles.

Referring to FIGS. 9, 12, 13 and 14, a ring shaped recess is shown in the interior face of each of the front part and the back part of the holder to securely position the coin envelope. The ring shaped recess could alternatively be formed on one or the other of the front part and the back part, but sized larger to accommodate the thickness of the perimeter of the coin envelope. The circular shape of the coin envelope and the ring shaped recess can permit the coin envelope to rotate or be rotated manually within the holder, depending on clearances and pressure exerted by the holder on the perimeter of the envelope. The envelope and corresponding recesses can be shaped other than circularly, which would prevent rotation of the coin envelope within the assembled holder.

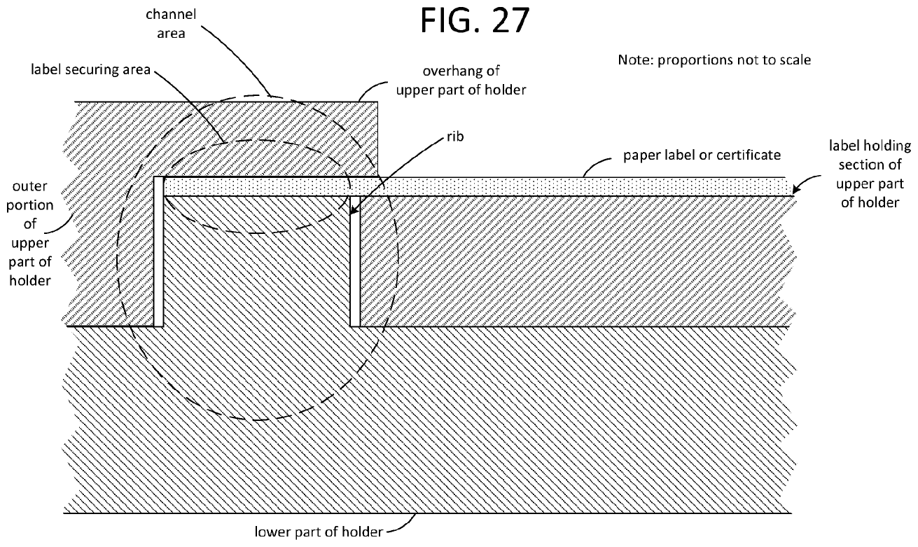

As shown in FIGS. 9 and 14, an interior face of the back part of the holder also includes two rows of nine ribs, illustrated using broken lines. The rows of ribs engage with channels, also illustrated using broken lines, on the interior face of the front part of the holder, shown in FIGS. 12 and 13, to secure a certification label, shown in FIG. 10, in place on a front face of the front part of the holder. A cross sectional view of how the ribs engage with the channel to hold the certification label in place will be discussed in additional detail below with respect to FIG. 27. As an alternative to the two rows of ribs illustrated as shown, single elongated raised tables could be used, but using single elongated raised tables can create shrinkage issues due to significant variations in thickness of plastic when molding the plastic back part. In one embodiment, the ribs and channels can be positioned along the top and bottom sides of the label rather than the left and right sides.

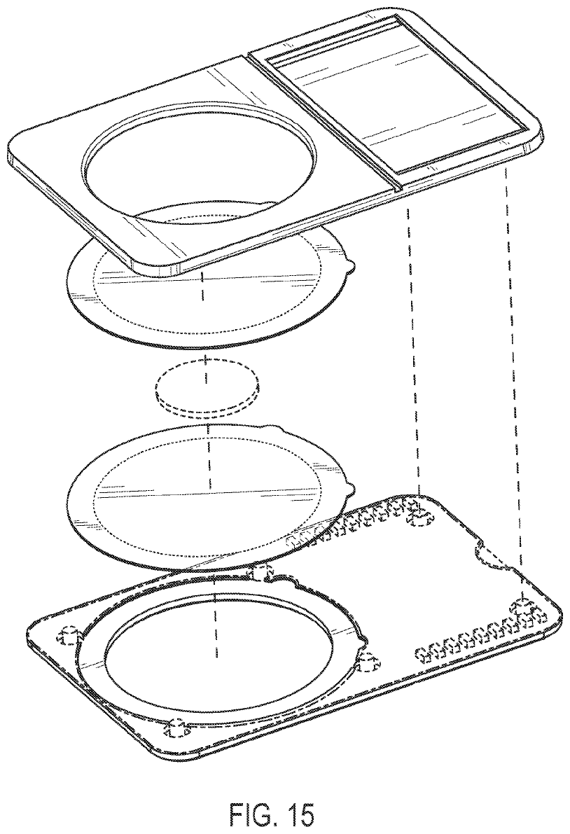

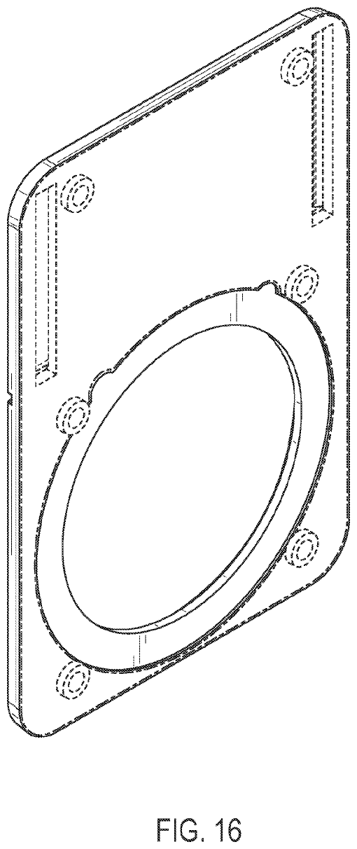

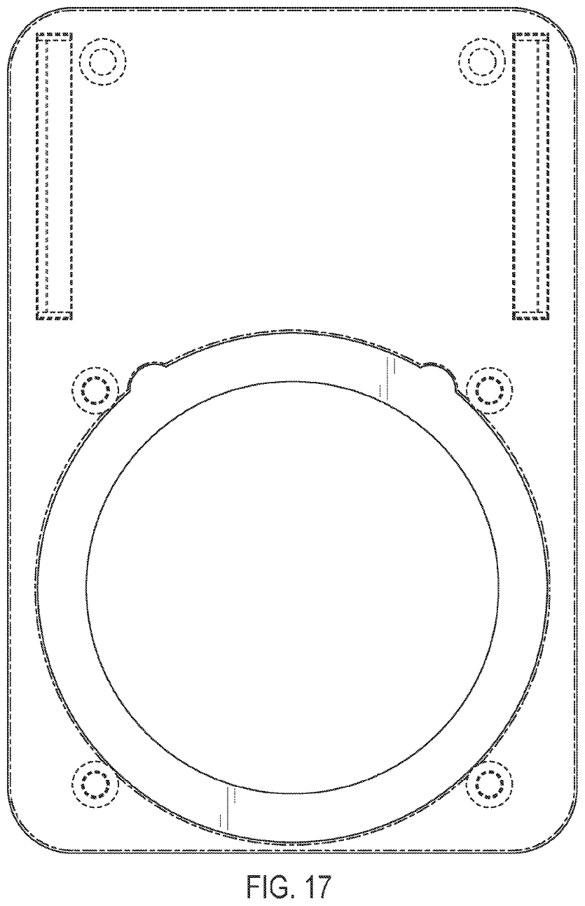

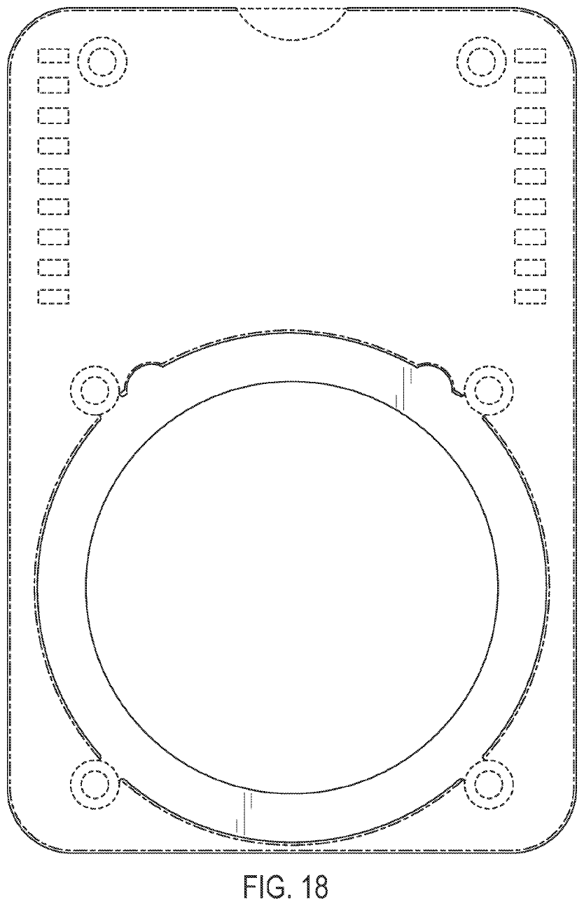

FIG. 15 is a perspective exploded view of the holder in accordance with a second embodiment. FIG. 16 is a perspective view of an interior side of a front part of the holder in accordance with the second embodiment. FIG. 17 is an elevation view of the interior side of the front part of the holder in accordance with the second embodiment. FIG. 18 is an elevation view of the interior side of a back part of the holder in accordance with the second embodiment. Medium-short dashed broken lines are not indicative of any structure and should be disregarded.

Referring to FIGS. 15-18, in the second embodiment, the two sheets of the coin envelope each include two protrusions that are received in corresponding cutouts in the recesses in the interior faces of the front part and/or the back part of the holder. The protrusions are aligned when the sheets are heat sealed together and the resulting protrusions in the envelope interlock with the cutouts to prevent rotation of the coin envelope in the holder.

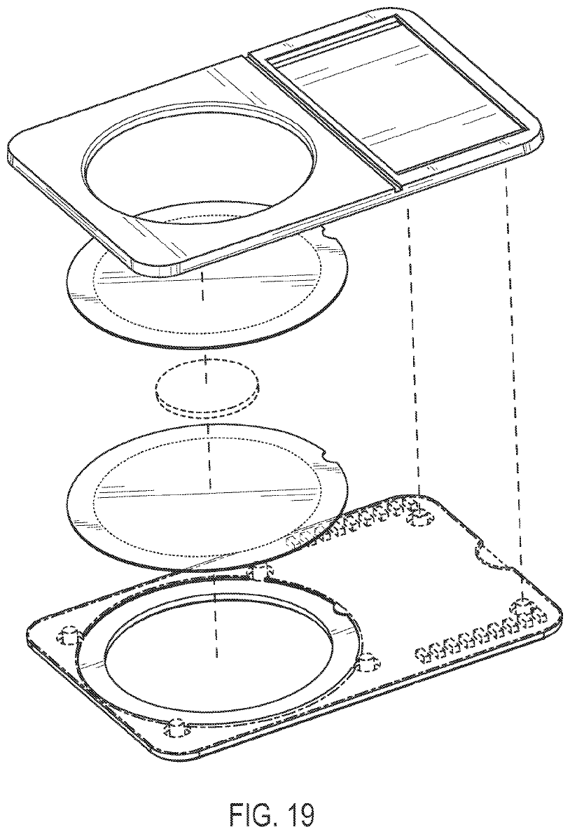

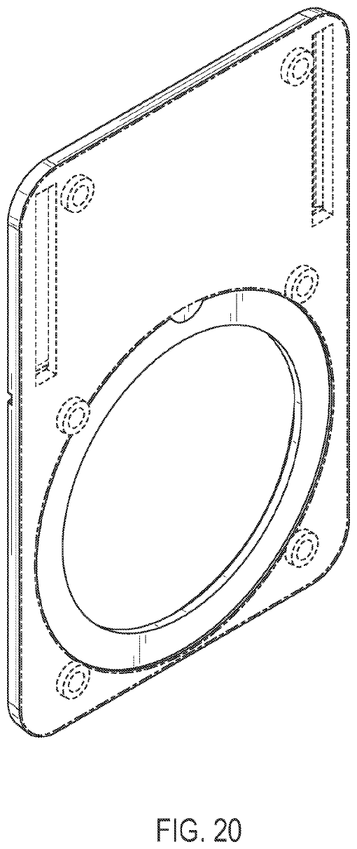

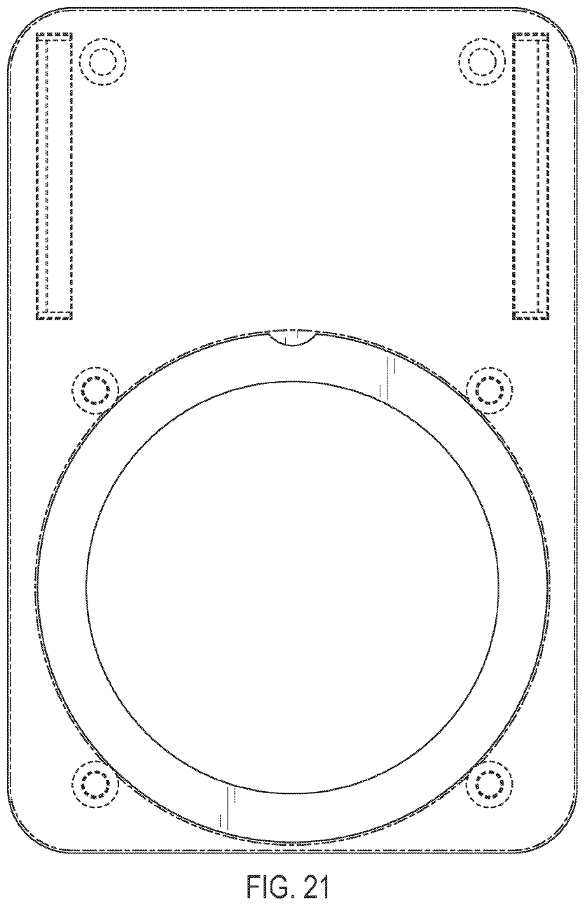

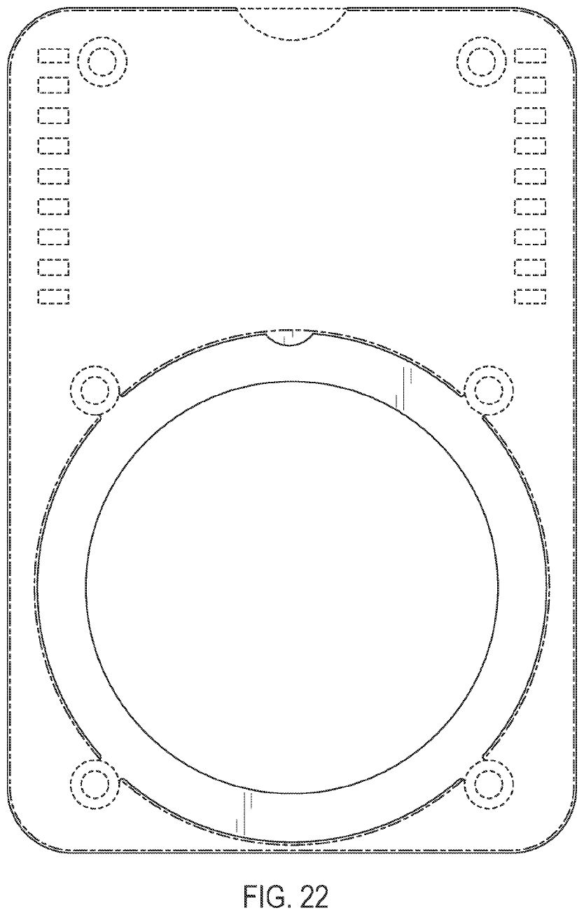

FIG. 19 is a perspective exploded view of the holder in accordance with a third embodiment. FIG. 20 is a perspective view of an interior side of a front part of the holder in accordance with the third embodiment. FIG. 21 is an elevation view of the interior side of the front part of the holder in accordance with the third embodiment. FIG. 22 is an elevation view of the interior side of a back part of the holder in accordance with the third embodiment. Medium-short dashed broken lines are not indicative of any structure and should be disregarded.

Referring to FIGS. 19-22, in the third embodiment, the recess in the interior face of each of the front part and the back part of the holder includes a protrusion that is received in a corresponding cutout in each of the two sheets of the coin envelope. The cutouts are aligned when the sheets are heat sealed together and the resulting cutout in the envelope interlocks with the protrusion to prevent rotation of the coin envelope in the holder. Alternatively, a cutout can be cut in a circular envelope after heat sealing has been completed. Two or more protrusions and corresponding cutouts can alternatively be used.

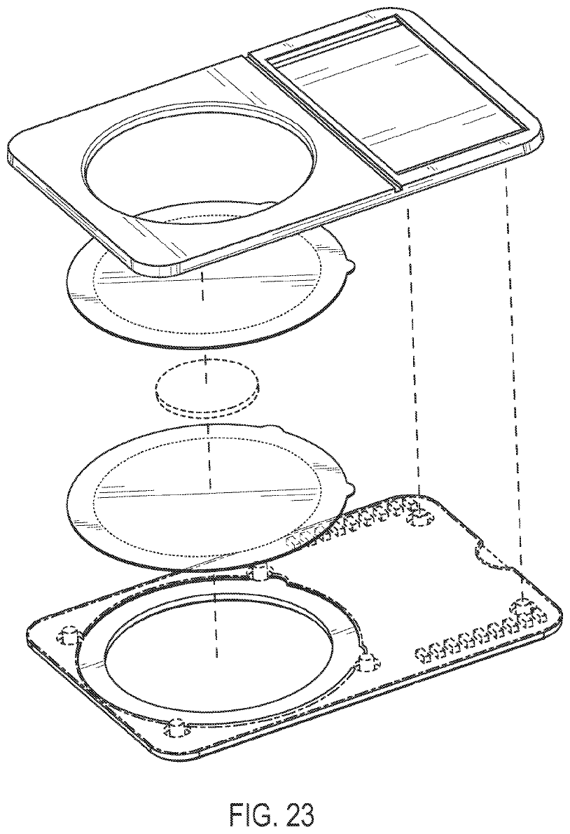

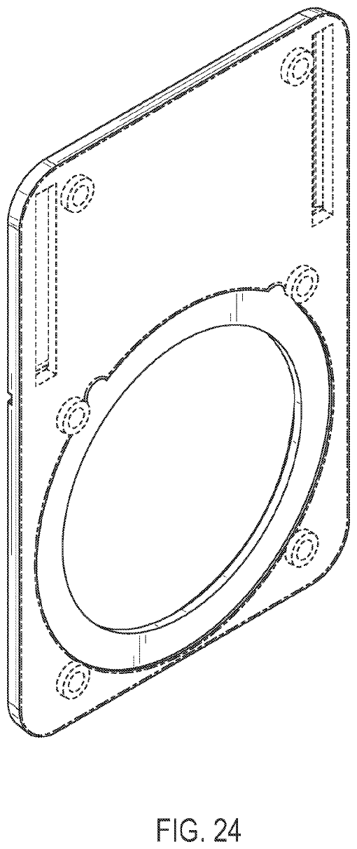

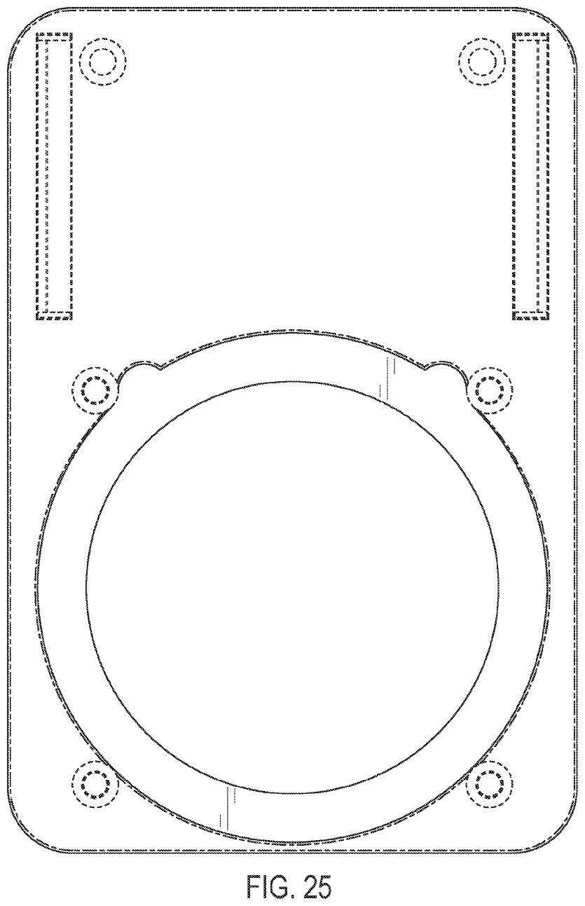

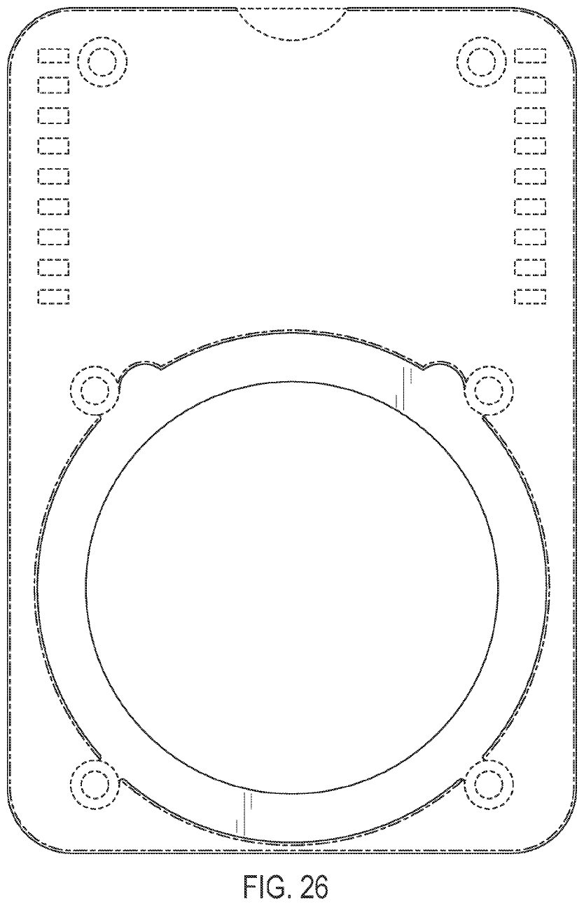

FIG. 23 is a perspective exploded view of the holder in accordance with a fourth embodiment. FIG. 24 is a perspective view of an interior side of a front part of the holder in accordance with the fourth embodiment. FIG. 25 is an elevation view of the interior side of the front part of the holder in accordance with the fourth embodiment. FIG. 26 is an elevation view of the interior side of a back part of the holder in accordance with the fourth embodiment. Medium-short dashed broken lines are not indicative of any structure and should be disregarded.

Referring to FIGS. 23-26, in the fourth embodiment, similarly to the second embodiment, the two sheets of the coin envelope each include two protrusions that are received in corresponding cutouts in the recesses in the interior faces of the front part and/or the back part of the holder. The protrusions are aligned when the sheets are heat sealed together and the resulting protrusions in the envelope interlock with the cutouts to prevent rotation of the coin envelope in the holder. In the fourth embodiment, the cutouts in the front part and back part of the holder are positioned adjacent the outer circumference of the interlocking receptacles on the front part of the holder. The correspondingly positioned protrusions or ears on the coin envelope can therefore be rotationally fixed by the receptacles in addition to or as an alternative to the cutouts.

The cutouts and corresponding protrusions on each of the envelope and the recess can take various forms and quantities in order to achieve an objective of preventing rotation of the coin envelope in the holder. A single protrusion and cutout could be used, or 2, 3, 4, 5, 6, 7, 8, 9 or more could be used. The cutout and protrusion can be rounded as in the third embodiment or can take on various other shapes such as V-shaped, semicircular, or rectangular. In one embodiment, the envelope can be configured with one or more flat edges, that align with corresponding flat edges of the recess. The envelope need not generally be circular in shape, and could take on other shapes, such as an octagonal shape. A combination between cutouts and protrusions on either or both of the envelope and recesses can be used.

In one embodiment, the envelope of the fourth embodiment can be used with the front and back parts of the first embodiment. In this configuration, the protrusions of the envelope would be rotationally fixed in place by the receptacles of the front part of the holder. Without corresponding cutouts for the protrusions, however, the front and back parts of the holder may not mate cleanly in the areas of the protrusions, but the envelope may be thin enough that the front and back parts snap together effectively around their perimeters without any noticeable gap when viewed from the outside.

FIG. 27 illustrates a cutaway cross section view of the holder sliced from one side towards the other along one of the ribs. The illustrated structure, not to scale, functionally shows how each rib of the lower part of the holder fits into the channel of the upper part of the holder to secure a paper label in place. The channel of the upper part of the holder is formed from an outer portion of the upper part of the holder, an overhang of the upper part of the holder and a label holding section of the upper part of the holder. A paper label is placed on the label holding area as illustrated in FIG. 10, and slid through a slot on each of the right and left sides such that it slides under an overhang on each of the right and left sides of the upper part of the holder. When the front and back parts of the holder are snapped together, each of the ribs will press a portion of either the right or left edge of the label up against the overhang of the upper part of the holder in a label securing area to secure the label in place.

Although the subject matter has been described in terms of certain embodiments, other embodiments that may or may not provide various features and aspects set forth herein shall be understood to be contemplated by this disclosure. The specific embodiments set forth herein are disclosed as examples only, and the scope of the patented subject matter is defined by the claims that follow. In the claims, a portion shall include greater than none and up to the whole of a thing.

1. A collectible coin holder comprising:
a coin envelope formed of two sheets of transparent flexible material encasing a collectible coin positioned between the two sheets, the two sheets being sealed together around a portion of a perimeter of the coin envelope to secure the coin between the two sheets;
a front part formed of plastic and having a label holding area holding a label; and
a back part formed of plastic,
wherein the front part and the back part have interior faces that are snapped together to secure the coin envelope in a viewing opening that extends through the front part and the back part, and
wherein at least one of the front part and the back part have a recess surrounding the viewing opening on an interior face, the recess shaped to match a portion of the perimeter of the coin envelope.

2. The coin holder of claim 1, wherein each of the front part and the back part have a recess and the recesses have a combined depth configured to accommodate a thickness of the coin envelope at the perimeter of the coin envelope.

3. The coin holder of claim 1, wherein only the front part has a recess, and the recess has a depth configured to accommodate a thickness of the coin envelope at the perimeter of the coin envelope.

4. The coin holder of claim 1, wherein only the back part has a recess, and the recess has a depth configured to accommodate a thickness of the coin envelope at the perimeter of the coin envelope.

5. The coin holder of claim 1, wherein the perimeter of the coin envelope is generally circular in shape and further has a cutout in the circular shape, and wherein the recess of the front part or the back part includes a protrusion configured to engage with the cutout to rotationally secure the coin envelope in the viewing opening.

6. The coin holder of claim 1, wherein the perimeter of the coin envelope is generally circular in shape and further has a protrusion from the circular shape.

7. The coin holder of claim 6, wherein the recess of the front part or the back part includes a cutout configured to engage with the protrusion to rotationally secure the coin envelope in the viewing opening.

8. The coin holder of claim 1, wherein the perimeter of the coin envelope is not generally circular in shape.

9. The coin holder of claim 1, wherein the two sheets are sealed together using heat.

10. The coin holder of claim 1, wherein the viewing opening is circular.

11. The coin holder of claim 1, further comprising:
two overhangs formed in the front part, each overhang extending over a portion of the label along one of two opposite sides of the label in position on the label holding area; and
at least two projections extending from the back part, each projection positioned to press a portion of an underside of the label on one of the opposite sides against one of the overhangs to secure the label in place.

12. A cased collectible coin comprising:
the collectible coin holder of claim 1;
the collectible coin encased within the coin envelope of the collectible coin holder; and
a transparent plastic outer case comprising a front part ultrasonically welded to a back part and encasing the collectible coin holder.

13. A method comprising:
sealing a collectible coin between two sheets of transparent flexible material to form a coin envelope having a sealed perimeter;
placing the coin envelope in a recess formed around a viewing opening in a front part or a back part of a collectible coin holder, wherein the front part has a label holding area holding a label; and
snapping the front part and the back part together to secure the coin envelope in the viewing opening between the front part and the back part.

14. The method of claim 13, wherein each of front part and the back part have a recess and the recesses have a combined depth configured to accommodate a thickness of the coin envelope at the perimeter of the coin envelope.

15. The method of claim 13, wherein only the front part has a recess, and the recess has a depth configured to accommodate a thickness of the coin envelope at the perimeter of the coin envelope.

16. The method of claim 13, wherein only the back part has a recess, and the recess has a depth configured to accommodate a thickness of the coin envelope at the perimeter of the coin envelope.

17. The method of claim 13, wherein the perimeter of the coin envelope is generally circular in shape and further has a cutout in the circular shape, and wherein the recess of the front part or the back part includes a protrusion configured to engage with the cutout to rotationally secure the coin envelope in the viewing opening.

18. The method of claim 13, wherein the perimeter of the coin envelope is generally circular in shape and further has a protrusion from the circular shape.

19. The method of claim 18, wherein the recess of the front part or the back part includes a cutout configured to engage with the protrusion to rotationally secure the coin envelope in the viewing opening.

20. The method of claim 13, wherein the perimeter of the coin envelope is not generally circular in shape.
